(19) United States
(12) Patent Application Publication
(10) Pub. No.: US 2007/0254147 A1
(43) Pub. Date: Nov. 1, 2007

(54) Polymer Film, a Packaging Laminate Comprising the Polymer Film, a Packaging Container Formed from the Packaging Laminate and a Process for the Production of the Polymer Film

(75) Inventors: Andre Chiquet, Givisiez (CH); Bertrand Jaccoud, Siviriez (CH); Pierre Fayet, Lausanne (CH)

Correspondence Address: BUCHANAN, INGERSOLL & ROONEY PC, POST OFFICE BOX 1404, ALEXANDRIA, VA, 22313-1404, US

(73) Assignee: Tetra Laval Holdings & Finance S.A., Pully (CH)

(21) Appl. No.: 11/661,971

(22) PCT Filed: Sep. 5, 2005
(86) PCT No.: PCT/IB05/02637

§ 371 Date: Mar. 6, 2007

(51) Int. Cl. B32B 27/04

(52) U.S. Cl. 428/327; 428/474.4; 428/478.8

(57) ABSTRACT

A polymer film comprising a gas barrier coating of SiOx directly coated onto a first side of a polymer carrier layer. The film also comprises a heat sealable polyolefin layer arranged on a second side of the polymer carrier layer. The invention also relates to a packaging laminate comprising the polymer film and to a packaging container produced from such a packaging laminate. The invention further relates to a process for the production of the polymer film.

### TECHNICAL FIELD OF THE INVENTION

The present invention relates to a polymer film comprising a gas barrier coating of SiOx directly coated onto a first side of a polymer carrier layer. The invention also relates to a packaging laminate comprising the polymer film and to a packaging container produced from such a packaging laminate. The invention further relates to a process for the production of the polymer film.

### BACKGROUND OF THE INVENTION

In the high-speed, continuous packaging processes well known for the paperboard packages of the Tetra Brik®-type, a web of the packaging laminate is continuously formed into a tube, filled with contents and sealed off to pillow-shaped packaging containers by a simultaneous heat sealing and cutting operation. The pillow-shaped packaging container is then normally fold formed into a parallelepipedic packaging container. The main advantage of this continuous tube-forming, filling and sealing packaging process concept is that the web may be sterilised continuously just before tube-forming, thus providing for the possibility of an aseptic packaging process, i.e. a process wherein the liquid content to be filled in as well as the packaging material itself are reduced from bacteria and the filled packaging container is produced under clean circumstances such that the filled package may be stored for a long time even at ambient temperature, without the risk of growth of micro-organisms in the filled product. An important factor for long-term storage is of course also the gas barrier properties of the filled and sealed packaging container, which in turn is highly dependent on the gas barrier properties of the packaging laminate itself. An other important advantage of the Tetra Brik®-type packaging process is, as stated above, the possibility of continuous high-speed packaging, which has considerable impact on cost efficiency.

The advantages of a SiOx gas barrier layer compared to other gas barrier materials are firstly that it has a positive environmental profile, secondly, that it is not affected when in contact with surrounding moisture or liquid. Furthermore, it allows for the contents of a package formed from the packaging laminate to be subjected to microwave heating, while the contents are in the package. Since it is applied in very thin layers, it is also relatively flexible and resistant to cracking when bent or folded.

However, tests have shown that if the polymer carrier layer onto which the SiOx coating is applied is too elastic, e.g. in terms of a high elongation at break or a low Young's Modulus, there will be problems in the runnability of the SiOx coating step.

Furthermore, too optimise the packaging laminate and the production of the same and the packaging container, there is an incentive to lower the costs, to simplify the structure of the packaging laminate, to decrease the number of converting steps needed and to provide a packaging laminate that is resistant to corrosion of the gas barrier by certain food components.

### ACCOUNT OF THE INVENTION

It is therefore an objective of the present invention to provide a packaging laminate that alleviates the above discussed disadvantages and problems and that fulfils at least some of the above requirements, preferably all of them.

Accordingly, it is an objective of the present invention to provide a thin, pre-manufactured polymer film for a packaging laminate/container, which film combines a high oxygen barrier in the entire humidity range, a sealing layer included in the film, a high strength, an improved runnability in SiOx coating, and lower costs.

The packaging laminate comprising the polymer film should be suitable for aseptic packaging and long-term storage, and have sufficient bending stiffness to be suitable for continuous, high speed packaging of liquid foods by means of a continuous tube-forming process.

The invention is also directed to a packaging container filled with solid, semi-solid or liquid food or beverage and produced from the packaging laminate comprising the polymer film.

These and other objectives are achieved by means of the polymer film, the packaging laminate, the packaging container and the process for the production of the polymer film according to the invention, as defined in the appended claims.

Accordingly, the present invention provides a pre-manufactured polymer film comprising a gas barrier coating of SiOx directly coated onto a first side of a polymer carrier layer, which film also comprises a heat sealable polyolefin layer arranged on a second side of said polymer carrier layer.

Preferably, said polymer carrier layer is a layer of a material in the group that consists of polyamide, polyamide copolymer, polyethylene terephthalate copolymer and polyethylene naphthalene and optionally said polymer carrier layer is composed of up to four part-layers of the same polymer material, optionally with binding layers in-between. Suitably, the polymer carrier layer has a total thickness of 1-20 μm, preferably 1-10 μm, independent on if it is a mono-layer or a multi-layer, in case of a multi-layer however not including optional binding layers between part-layers.

Most preferred, the intermediate film, onto which the SiOx coating is applied, i.e. the film including said polymer carrier layer, said heat sealable polyolefin layer, and optional binding layer(s), is an oriented film, and even more preferred a mono-oriented film. As shall be further described below, this can be achieved by (mono-axial) stretching of the film such that its thickness is reduced, before the SiOx coating is applied onto it. It has been found that an oriented polymer film, especially a mono-oriented polymer film, as compared to a non-oriented polymer film, has a lower elongation at break and a higher Young's Modulus. The lower elongation at break and higher Young's Modulus enables improved runnability in the SiOx coating, due to the film being more stable, especially more heat stable.

According to another aspect of the invention, the heat sealable polyolefin layer of the polymer film, is a layer of a material in the group that consists of polyethylene, metallocene polyethylene, polyethylene copolymer, polypropylene and polypropylene copolymer. Optionally, said heat sealable polyolefin layer is composed of up to seven part-layers of the same basic polyolefin material. Here, it should be understood that e.g. polyethylene materials of all grades, including e.g. metallocene polyethylene, polyethylene copolymers, as well as low density, linear low density, medium density polyethylene, high density polyethylene, etc., optionally also of metallocene and/or copolymer type, are considered to be materials of the same basic polyolefin material. Also, one or more shock-absorbing layers can be incorporated within said structure of up to seven part-layers, or can be arranged between these up to seven part-layers and the carrier layer or an optional binding layer that binds to the carrier layer. The shock-absorbing layer(s) is/are composed of a thermoplastic polymer with high elastomeric properties, which is preferably selected from the group consisting of very low density polyethylene, ultra low density polyethylene, polyethylene copolymers, polyethylene terpolymers and polyolefin-based elastomers and plastomers. The shock-absorbing layer(s) may have a thickness of 5-50 μm, preferably 10-25 μm.

Suitably, the heat sealable polyolefin layer of the film has a total thickness of 5-50 μm, preferably 10-25 μm, independent on if it is a mono-layer or a multi-layer, but excluding any optional shock-absorbing layer(s). In case one or more shock-absorbing layer(s) is/are present, the thickness of the heat sealable polyolefin layer will be in the lower region of the just mentioned range.

Most preferred, the outermost heat sealable polyolefin layer or part-layer comprises a metallocene polyethylene material, on the side of the film/laminate that is intended to face the interior of the packaging container to be formed from the same. Suitably, said metallocene polyethylene material is a metallocene low density polyethylene material, preferably a metallocene linear low density polyethylene material.

According to yet another aspect of the invention, the polymer film also comprises a binding layer between said polymer carrier layer and said heat sealable polyolefin layer and optionally between part-layers of the polymer carrier layer. Suitably, said binding layer is constituted by LDPE, LLDPE or grafted PP and has a thickness of 0.5-8 μm, preferably 1-5 μm. Of course, other binding layers of adhesive polymers, tie layers and primers, known in the art, can be used for optimal adhesion between the various layers of the packaging laminate. Such binding layers and primers are adapted to the specific choices of polymer in the various layers and may be selected from polyolefins and modified polyolefins, preferably polyethylene-based polymers.

Examples of binding layers are LDPE homo- or copolymers or graft copolymers of polyethylene, grafted with monomers comprising carboxylic or glycidyl functional groups, such as acrylic monomers or maleic anhydride (MAH) monomers, for example ethylene (meth)acrylic acid copolymer (E(M)AA), ethylene-glycidyl(meth)acrylate copolymer (EG(M)A)) or MAH-grafted polyethylene (MAH-g-PE).

According to a further aspect of the invention, the pre-manufactured film of the invention has a total thickness of 8-60 μm, preferably 10-40 μm. It should have an oxygen transmission rate of less than 50, preferably less than 20 most preferred less than 1 cm³/(m^{2*}24 h), 1 atm O₂.

The invention also relates to a packaging laminate comprising a film according to the invention. The packaging laminate further comprises a paper or paperboard bulk layer arranged to provide for the greatest contribution to the flexural rigidity of the laminate. It is however also conceivable that the bulk or core layer of the laminate instead is a polyolefin bulk layer, made e.g. of polyethylene, polypropylene or copolymers of ethylene, such as, for example, ethylene-propylene, ethylene-butene, ethylene-hexene, ethylene-alkyl(meth)-acrylate or ethylene-vinyl acetate copolymers. The choice of the material for such a polyolefin core layer may provide for a transparent packaging laminate, to be used e.g. in a transparent pouch for food.

It is intended that the heat sealable polyolefin layer of the pre-manufactured film forms a free surface of the packaging laminate, which surface is intended for food contact, as it directly faces the interior of a packaging container formed from the packaging laminate and filled with a food product. However, it may be conceived, although less preferred, that one or more additional heat sealable layers is/are applied onto the film in connection with its incorporation in the packaging laminate, in which case the outermost additional heat sealable layer on the inside of the container is intended for direct food contact.

Furthermore, the packaging laminate comprises one or more outer heat sealable polyolefin layer(s) arranged on an opposite side of the bulk or core layer. Such outer heat sealable polyolefin layer(s) will directly face the surrounding environment of the packaging container.

A laminate according to the invention is well adapted to be used in connection with ultrasonic vibration heat sealing, although the sealing technique is not restricted to that.

The packaging container formed from the packaging laminate according to the invention may be of any known shape. Preferably, it is a brick- or wedge-shaped container that is durable at handling and distribution and resistant to moisture and oxygen gas during long term storage, due to the high quality packaging laminate, which in turn also provides for high seal quality and excellent gas barrier properties. A further important advantage of packaging containers produced from the packaging laminate according to the invention is that they are durable to microwave cooking or thawing, as well as retorting.

The invention further relates to a process for the production of a polymer film comprising a gas barrier coating of SiOx, which process comprises the steps of:

a) forming a polymer carrier layer and a heat sealable polyolefin layer, and joining these layers together to form an intermediate film,

b) directly applying said coating of SiOx onto said polymer carrier layer, to form said film.

According to a preferred embodiment of the process, there is an intermediate step after step (a) but before step (b), of orienting, preferably mono-orienting, said film by stretching, preferably mono-axial stretching. Preferably, a thickness of the film is reduced by up to 80%, preferably by 60-75%, by said stretching. Another way of expressing this is that in a preferred embodiment, a thickness of the film is reduced from 30-250 μm to 8-60 μm, preferably from 50-160 μm to 10-40 μm, by said stretching. The invention is however not limited to those thicknesses, but other ranges are conceivable. Yet another way of defining the stretching is that the elongation at break of the film is reduced from usually being higher than 300%, to being less than 200%, preferably less than 100%, by said stretching, or that the Young's Modulus of the film is increased to above 400 MPa, preferably above 600 MPa and most preferred above 1000 MPa, by said stretching. The increase of the Young's Modulus improves runnability in the SiOx coating step.

According to one aspect of the process according to the invention, said film is formed in step (a) by co-extrusion casting or co-extrusion blowing the polymer carrier mono- or multi-layer and said heat sealable polyolefin mono- or multi-layer, together with the binding layer and optional additional binding layers between optional part-layers of the polymer carrier multi-layer.

The SiOx coating applied in step (b), is preferably applied by means of the continuous method of plasma enhanced chemical vapour deposition, PECVD, of SiOx from a plasma of an organic silicon compound, such as hexadimethylsiloxane (HDMSO), wherein x=1.7-2.2, and the coating is given a thickness of 50-500 Å, preferably 80-300 Å.

Thanks to the pre-manufactured film, that functions both as a carrier layer for the SiOx coating and is provided with a heat sealable layer, the structure of the packaging laminate is simplified and the number of converting steps needed is decreased, whereby costs are lowered. Also, the film combines a high oxygen barrier in the entire humidity range, has a high strength, and results in an improved runnability in the SiOx coating step.

### DESCRIPTION OF THE DRAWINGS

Further advantages and favourable characterising features of the present invention will be apparent from the following detailed description, with reference to the appended figures, in which:

FIG. 1A is a cross-sectional view of a preferred pre-manufactured polymer film according to the present invention,

FIG. 1B is a cross-sectional view of a second embodiment of a pre-manufactured polymer film according to the present invention,

FIG. 1C is a cross-sectional view of a third embodiment of a pre-manufactured polymer film according to the present invention,

FIG. 2 is a cross-sectional view of a laminated packaging material according to the present invention, including a film according to the invention,

FIG. 3 shows an example of a packaging container produced from the packaging laminate according to the invention,

FIG. 4 is a diagrammatic view of a plant for co-extrusion blowing of an intermediate film,

FIG. 5 is a diagrammatic view of a plant for SiOx coating of the intermediate film produced in FIG. 4.

### DESCRIPTION OF PREFERRED EMBODIMENTS

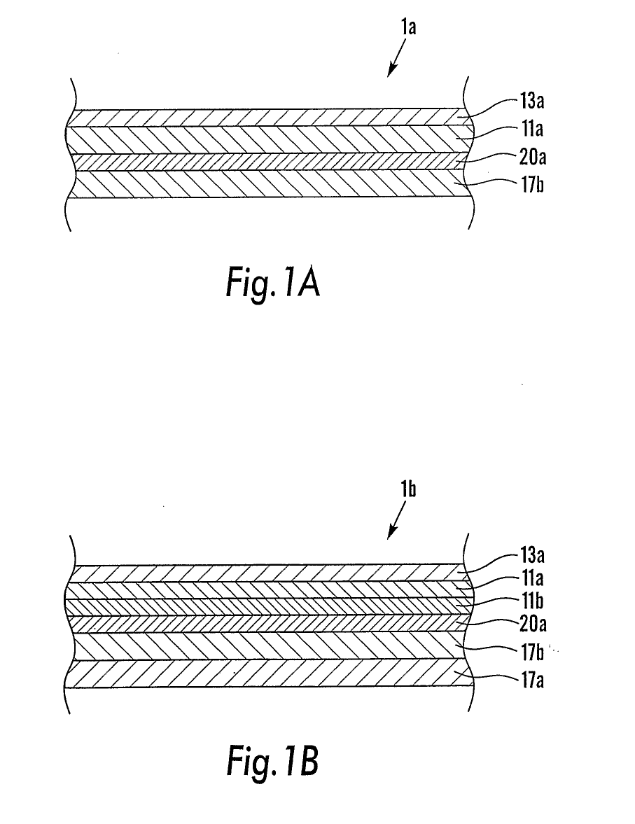

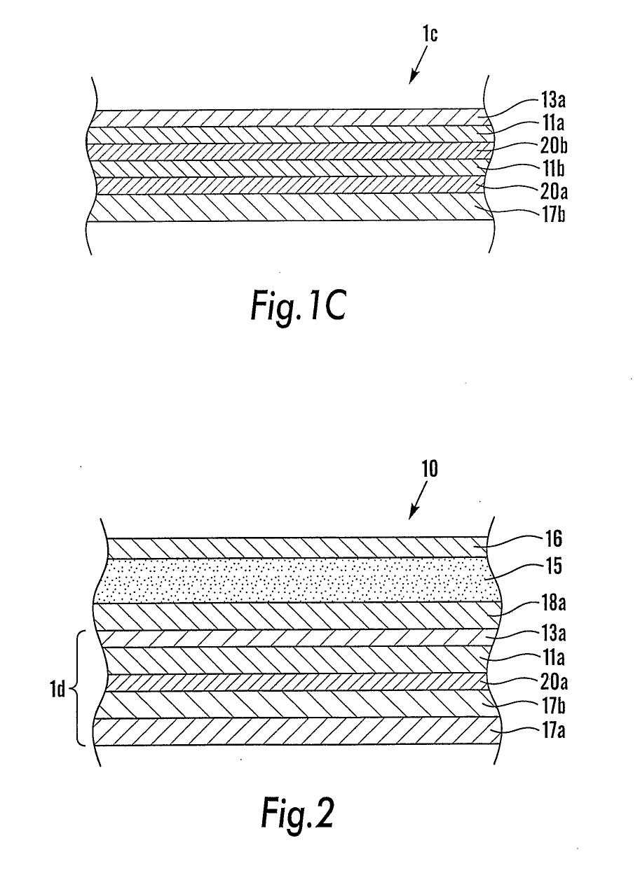

FIG. 1A shows a preferred film according to the invention, generally denoted 1a. It comprises a polymer carrier layer 11a of polyamide, having a thickness of 1-10 μm. The polymer carrier layer 11a is bonded to a heat sealable polyolefin layer 17b of polyethylene, by a binding layer 20a composed of LDPE, LLDPE or grafted PPa. Typically, the thickness of the heat sealable polyolefin layer 17b is 10-25 μm and the thickness of the binding layer 20a is 1-5 μm. The heat sealable polyolefin layer 17b is intended to directly face the food contents of a packaging container formed from a packaging laminate that includes the film 1a.

Onto the film 1a, i.e. onto the free surface of the polymer carrier layer 11a, a thin gas barrier layer 13a of SiOx has been coated by means of plasma enhanced chemical vapour deposition (PECVD).

All layers of the film 1a (and films 1b, 1c, 1d, described below), except the SiOx coating, are preferably oriented, most preferred mono-oriented.

The film 1b in FIG. 1B differs from film 1a in that the polymer carrier layer is a multi-layer composed of two part-layers 11a, 11b of polyamide. Similarly, the heat sealable polyolefin layer of polyethylene is a multi-layer composed of two part-layers 17a, 17b. The outermost heat sealable polyolefin 17a of a heat-sealable polyolefin comprises suitably a metallocene polyethylene material. Also suitably, the outermost heat sealable polyolefin layer 17a has been co-extruded together with the heat sealable polyolefin layer 17b, but beneficially at a higher temperature. The total thicknesses of the multi-layers 11a, 11b and 17a, 17b are the same as indicated for FIG. 1A.

The film 1C in FIG. 1C differs from film 1a in that a second binding layer 20b, suitably of the same type as the binding layer 20a, has been added between the part-layers 11a and 11b of the multi-layer polymer carrier layer.

The films 1a, 1b and 1c shown in FIGS. 1A, 1B and 1C, respectively, should be seen as mere examples, from which the person skilled in the art will have no problems in deducing a variety of other embodiments. Generally, the film may comprise from three to nine different layers being polymer carrier layers, binding layers and heat sealable polyolefin layers, said number of layers however not including the SiOx coating.

FIG. 2 shows a packaging laminate 10, comprising another conceivable variant of a pre-manufactured film 1d composed of a polymer carrier layer 11a, a binding layer 20a, a first heat sealable polyolefin part-layer 17b and a second heat sealable polyolefin part-layer 17a, onto which film 1d (more precisely onto the polymer carrier layer 11a surface of the film 1d) a thin gas barrier layer of SiOx 13a has been coated by means of plasma enhanced chemical vapour deposition (PECVD).

The thickest layer in the laminate is a bulk paper or paperboard layer 15. It is directly bonded to the SiOx layer 13a, by means of a binding layer 18a. It is preferred, but not limited to, that said binding layer 18a comprises a polyolefin grafted with an unsaturated alkoxysilane, said grafted polyolefin preferably being blended with a non-grafted polyolefin, in said binding layer, which provides for exceptionally good adhesion between the SiOx layer 13a and the paper or paperboard layer 15. Suitably, the grafted polyolefin and the non-grafted polyolefin in the binding layer are polyolefins of the same type, preferably polyethylene type polyolefins. It is preferred that the binding layer comprises 30-70% by weight of the grafted polyolefin. The binding layer 18a typically has a basis weight of 5-30 g/m², in this embodiment of the invention.

On the outside of the paper or paperboard layer 15, which will constitute the outside wall of a packaging container produced from the packaging laminate, is applied an outermost layer 16 of a heat-sealable polyolefin, preferably a low density polyethylene (LDPE) or a linear low density polyethylene (LLDPE), which includes also so-called metallocene-catalysed LLDPE's (m-LLDPE), i.e. LLDPE polymers catalysed by means of a single site catalyst. Other examples of alternative polymers for the outside packaging wall layer may be medium high density polyethylene (MDPE) or polypropylene (PP).

It is to be understood that the packaging laminate shown in FIG. 2 should be seen as a mere example, from which the person skilled in the art will have no problems in deducing a variety of other embodiments. It is even conceivable that the packaging laminate may comprise two SiOx coated films according to the invention, although not necessarily being absolutely identical, which films are mirrored in the bulk or core layer 15.

The packaging laminate 10 according to the invention can be produced according to any suitable prior art principle known to the skilled man. For example, with reference to the laminate 10 shown in FIG. 1, the binding layer 18a may be extruded into a laminator nip, between the paper or paperboard bulk layer 15 and the pre-manufactured SiOx coated film 1d. The SiOx layer is treated by flame, plasma or corona treatment before being laminated to the paper or paperboard bulk layer. Finally the outermost layer 16 of a heat-sealable polyolefin is extruded onto the paper or paperboard bulk layer 15.

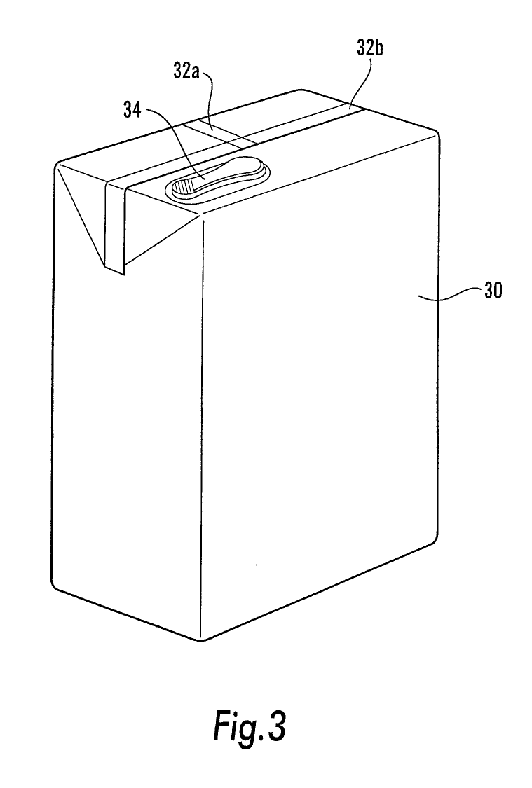

FIG. 3 shows a preferred example of a packaging container 30 produced from the packaging laminate 10 according to the invention. The packaging container is particularly suitable for beverages, sauces, soups or the like. It is especially advantageous that the packaging container can be micro-waved, if it contains sauce or soup or the like, after having been punctured. Typically, such a package has a volume of about 100 to 1000 ml. It may be of any configuration, but is preferably brick-shaped, having longitudinal and transversal seals 32a and 32b, respectively, and optionally an opening device 34. In another embodiment, not shown, the packaging container may be shaped as a wedge, such that it is easy to handle and dimensionally stable when put on a shelf in the food store or on a table or the like. In order to obtain such a “wedge-shape”, the bottom part of the package is fold formed such that the transversal heat seal of the bottom is hidden under the triangular corner flaps, which are folded and sealed against the bottom of the package.

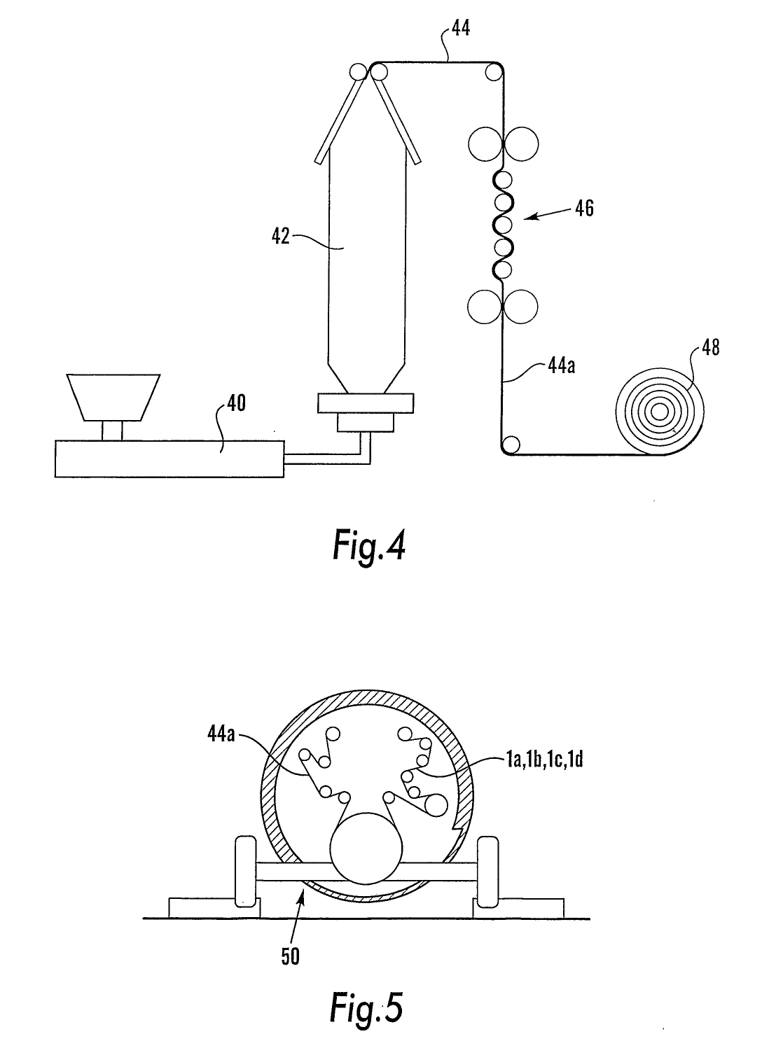

FIG. 4 is a diagrammatic view of a plant for co-extrusion blowing of an intermediate film, i.e. the film before being coated by SiOx. The polymer carrier layer(s), the binding layer(s) and the heat sealable polyolefin layer(s) are co-extruded 40 and blow 42, to form a film 44 of relatively high thickness. Then, the film 44 is subjected to mono-axial stretching 46 between rolls, while it is hot, such that the thickness of the film is reduced 44a and the polymer carrier layer becomes mono-oriented and gets a certain degree of inherent stiffness due to a relatively higher degree of crystallinity than non-oriented polymer films. The resulting intermediate film is then wound to a roll 48.

The film 44 has the form of a tube, when it exits the extrusion-blower 42, and may be opened/slit before being stretched. If necessary, two parallel orienters/stretchers 46 may be used in that case. It is also possible to perform the stretching off-line.

Other methods of forming the intermediate film, such as co-extrusion casting e.g., are obvious to the person skilled in the art.

FIG. 5 is a diagrammatic view of a plant for SiOx coating of the intermediate film produced in FIG. 4. The stretched film 44a from FIG. 4 is subjected, on its polymer carrier layer side, to continuous plasma enhanced chemical vapour deposition 50, PECVD, of SiOx from a plasma of an organic silicon compound, such as hexadimethylsiloxane (HDMSO), wherein x=1.7-2.2, and the coating is given a thickness of 50-500 Å, preferably 80-300 Å, so that the film 1a, 1b, 1c, 1d of the invention is formed.

By way of conclusion it should be observed that the present invention which has been described above with particular reference to the accompanying drawings, is not restricted to these embodiments described and shown exclusively by way of example, and that modifications and alterations obvious to a person skilled in the art are possible without departing from the inventive concept as disclosed in the appended claims.

1. A polymer film comprising a gas barrier coating of SiOx directly coated onto a first side of a polymer carrier layer, and a heat sealable polyolefin layer arranged on a second side of said polymer carrier layer.

2. A polymer film according to claim 1, wherein said polymer carrier layer is a layer of a material in the group that consists of polyamide, polyamide copolymer, polyethylene terephthalate copolymer and polyethylene naphthalene.

3. A polymer film according to claim 2, wherein said polymer carrier layer is composed of up to four part-layers of the same basic polymer material.

4. A polymer film according to claim 1, wherein said polymer carrier layer and said heat sealable polyolefin layer are oriented polymer layers.

5. A polymer film according to claim 1, wherein said polymer carrier layer has a thickness of 1-20 μm.

6. A polymer film according to claim 1, wherein said heat sealable polyolefin layer is a layer of a material in the group that consists of polyethylene, metallocene polyethylene, polyethylene copolymer, polypropylene and polypropylene copolymer.

7. A polymer film according to claim 6, wherein said heat sealable polyolefin layer is composed of up to seven part-layers of the same basic polyolefin material.

8. A polymer film according to claim 1, wherein said heat sealable polyolefin layer has a thickness of 5-50 μm.

9. A polymer film according to claim 1, further comprising: i) at least one shock-absorbing layer incorporated within said heat sealable layer; ii) at least one shock absorbing layer arranged between said heat sealable layer and said carrier layer; or iii) a binding layer that binds to said carrier layer.

10. A polymer film according to claim 9, further comprising at least one shock-absorbing layer incorporated within said heat sealable layer or arranged between said heat sealable layer and said carrier layer, said at least one shock-absorbing layer being composed of a thermoplastic polymer with high elastomeric properties selected from the group consisting of very low density polyethylene, ultra low density polyethylene, polyethylene copolymers, polyethylene terpolymers and polyolefin-based elastomers and plastomers.

11. A polymer film according to claim 10, wherein said at least one shock-absorbing layer has a thickness of 5-50 μm.

12. A polymer film according to claim 1, further comprising a binding layer between said polymer carrier layer and said heat sealable polyolefin layer, which binding layer is oriented.

13. A polymer film according to claim 12, wherein said binding layer is constituted by one of a low density polyethylene adhesives, a linear low density polyethylene adhesive, or a grafted polypropylene adhesive.

14. A polymer film according to claim 12 wherein said binding layer has a thickness of 0.5-8 μm.

15. A polymer film according to claim 1, wherein said polymer film has a total thickness of 8-60 μm.

16. A polymer film according to claim 1, wherein said polymer film has an elongation at break of less than 200%.

17. A polymer film according to claim 1, wherein said polymer film has a Young's Modulus of above 400 MPa.

18. A polymer film according to claim 1, wherein said polymer film has an oxygen transmission rate of less than 50 cm³/(m^{2*}24 h), 1 atm O₂.

19. A packaging laminate 4 comprising a film that comprises a gas barrier coating of SiOx directly coated onto a first side of a polymer carrier layer said film also comprising a heat sealable polyolefin layer arranged on a second side of said polymer carrier layer.

20. A packaging laminate according to claim 19, further comprising a paper or paperboard bulk layer.

21. A packaging laminate according to claim 19, said heat sealable polyolefin layer forms an open surface of the packaging laminate, which surface is intended for food contact.

22. A packaging laminate according to claim 20, further comprising a binding layer, directly joining said coating of SiOx and said paper or paperboard bulk layer, which binding layer comprises a polyolefin grafted with an unsaturated alkoxysilane, said grafted polyolefin being blended with a non-grafted polyolefin, in said binding layer.

23. A packaging laminate according to claim 22, further comprising at least one outer heat sealable polyolefin layer arranged on a side of said paper or paperboard bulk layer opposite said binding layer.

24. A packaging container formed from a packaging laminate according to claim 19.

25. A packaging container according to claim 24, wherein the packaging container is filled with a food product and said heat sealable polyolefin layer of the film is in direct contact with said food product.

26. A process for the production of a polymer film comprising a gas barrier coating of SiOx, which process comprises: a) forming a polymer carrier layer and a heat sealable polyolefin layer, and joining the polymer carrier layer and the heat sealable polyolefin layer together to form an intermediate film; b) directly applying said coating of SiOx onto said polymer carrier layer to form said polymer film.

27. A process according to claim 26, further comprising, after (a) but before (b), orienting said intermediate film by stretching.

28. A process according to claim 27, wherein a thickness of the intermediate film is reduced by up to 80% by said stretching.

29. A process according to claim 27, wherein a thickness of the intermediate film is reduced from 30-250 μm to 8-60 μm by said stretching.

30. A process according to claim 27, wherein an elongation at break of the intermediate film is reduced to less than 200% by said stretching.

31. A process according to claim 27, wherein the Young's Modulus of the intermediate film is increased to above 400 MPa by said stretching.

32. A process according to claim 26, wherein said polymer carrier layer is formed in (a) from a material in the group that consists of polyamide, polyamide copolymer, polyethylene terephthalate copolymer and polyethylene naphthalene.

33. A process according to claim 32, wherein said polymer carrier layer is formed from up to four part-layers of the same basic polymer material.

34. A process according to claim 26, wherein said heat sealable polyolefin layer is formed in (a) from a material in the group that consists of polyethylene, metallocene polyethylene, polyethylene copolymer, polypropylene and polypropylene copolymer.

35. A process according to claim 34, wherein said heat sealable polyolefin layer is formed from up to seven part-layers of the same basic polyolefin material.

36. A process according to claim 26, further comprising forming a binding layer between said polymer carrier layer and said heat sealable polyolefin layer.

37. A process according to claim 36, said binding layer is formed from a polyolefin grafted with an unsaturated alkoxysilane, said grafted polyolefin being blended with a non-grafted polyolefin, in said binding layer.

38. A process according to claim 26, wherein said intermediate film is formed in (a) by coextrusion of said polymer carrier layer and said heat sealable polyolefin layer.

39. A process according to claim 26, wherein said coating of SiOx is applied in (b) by plasma enhance chemical vapor deposition, wherein x=1.7-2.2, and the coating possesses a thickness of 50-500 Å.

40. A polymer film according to claim 2, wherein said polymer carrier layer is composed of two part-layers of the same polymer material, and comprising a binding layer between the two part-layers.

41. A process according to claim 32, wherein the forming of the polymer carrier layer comprises forming the polymer carrier layer as two part-layers of the same basic polymer material with a binding layer between the two part-layers.
